(19) United States
(12) Patent Application Publication
(10) Pub. No.: US 2003/0101146 A1
(43) Pub. Date: May 29, 2003

(54) Dynamic pricing engine

(76) Inventors: Chin Lay David Yeo, Singapore (SG); Lai Chwang Chua, Singapore (SG); Juin Kuan Chong, Singapore (SG); Sew Kein Lee, Singapore (SG); Cheng Leng Ng, Kuala Lumpur (MY)

Correspondence Address: Grant Patent Services, Suite 210, 2120 L Street, N.W., Washington, DC, 20037, US

(21) Appl. No.: 09/990,593

(22) Filed: Nov. 23, 2001

(51) Int. Cl. G06F 17/00

(52) U.S. Cl. 705/400

(57) ABSTRACT

The present invention recognises that the right price has to be set at the right time so as to facilitate the clearing of residual service capacity at any instance. The need to facilitate the clearing of residual service capacity is especially eminent in cases where the services are perishable. The limited capacity of these services changes a consumer's willingness to pay as the time-to-service reduces, the residual service capacity depletes, and the number of consumers increases. The combination of attributes for a service can be varied to produce a selection of service profiles. The value that a consumer places on each service profile can be determined based on the time-to-service, the residual service capacity, and the number of competing bids when a service profile is selected. This allows the price for each service profile to be optimally updated, facilitating the swift clearing of residual service capacity in the process.

### FIELD OF INVENTION

The present invention relates generally to a dynamic pricing engine for use in a market valuation system. In particular, the invention relates to a system for the market valuation of services.

### BACKGROUND

The pricing issue for services is more complex than that of traditional product pricing due to the inherent sensitivity of factors relating to time-to-service, capacity limitation and service perishability. Due to the perishability of a service, it is in the interest of service providers to set the right price so that the capacity is cleared as much as possible in every instance. Due to capacity limitation, a consumer's willingness to pay varies as the remaining time prior to the commencement of a service reduces, the number of available services reduces and the number of consumers on the market for the service increases.

As such, the traditional pricing model is seen to be inadequate in capturing the unusual aspects of the demand for services. In particular, factors relating to the residual services indicating the number of remaining services, the competing bids quantifying the cumulative number of selections for each service profile by previous users, and time-to-service indicating the time remaining prior to the commencement of a service are important in determining consumers' willingness to pay. Failure to capture these three aspects of demand for services results in sub-optimal pricing decision to the service providers. This results in a situation where a service provider setting either a higher price that results in unused capacity, or a lower price that results in unsatisfied demand and hence perception of lower service quality. Either way, this translates into lower profit for a service provider. However, the ability to accurately determine a consumer's willingness to pay, over time, allows a service to discriminately set a time-dependant and a consumer-dependant price for a service.

Hence, this clearly affirms a need for a valuation methodology that addresses the foregoing problems.

### SUMMARY

Embodiments of the invention are provided and described hereinafter based on the principle that the right price is to be set at the right time so as to facilitate the clearing of residual service capacity at any instance. The need to facilitate the clearing of residual service capacity is especially eminent in cases where the services are perishable. The embodiments are further based on the principle that due to the limited capacity of these services, a consumer's willingness to pay changes as the time-to-service reduces, the residual service capacity depletes, and the number of consumers increases.

The combination of attributes for a service is varied to produce a selection of service profiles. The service profiles and their respective prices are made available to the consumers. A consumer proceeds to select one or more service profile with regards to time-to-service, residual service capacity, and number of consumers. The consumer is required to rank the service profile selected based on preference if more than one service profile is selected. As such, the value that a consumer places on each service profile is determined based on time-to-service, residual service capacity, and number of competing bids from other competing consumers when a service profile is selected. This allows the price for each service profile to be optimally updated, facilitating the swift and efficient clearing of residual service capacity in the process.

In accordance with a first aspect of the invention, there is disclosed a method for the valuation of services, the method comprising the steps of:

generating at least one service profile for a service, a service profile defining a combination of any of a plurality of profile attributes, wherein each profile attribute represents a particular characteristic that the service profile can possess;

generating a price for each service profile;

providing to a user, for each service profile, a residual services quantification, the residual services indicating the number of remaining services, a competing bids quantification, the competing bids quantifying the cumulative number of selections for each service profile by previous users, and a time-to-service indication, the time-to-service indicating the time remaining prior to the commencement of a service;

selecting one or more service profiles by the user;

creating a selected profiles list, the selected profiles list containing the service profiles selected by the user; and

updating the price for each service profile.

In accordance with a second aspect of the invention, there is disclosed a system for the valuation of services, the system comprising the means for:

generating at least one service profile for a service, a service profile defining a combination of any of a plurality of profile attributes, wherein each profile attribute represents a particular characteristic that the service profile can possess;

generating a price for each service profile;

providing to a user, for each service profile, a residual services quantification, the residual services indicating the number of remaining services, a competing bids quantification, the competing bids quantifying the cumulative number of selections for each service profile by previous users, and a time-to-service indication, the time-to-service indicating the time remaining prior to the commencement of a service;

selecting one or more service profiles by the user;

creating a selected profiles list, the selected profiles list containing the service profiles selected by the user; and

updating the price for each service profile.

### BRIEF DESCRIPTION OF THE DRAWINGS

Embodiments of the invention are described hereinafter with reference to the following drawings, in which:

FIG. 1 shows a block diagram representing a system for the valuation of services;

FIG. 2 shows a block diagram representing a dynamic pricing engine in the system of FIG. 1 for the valuation of services;

FIG. 3 shows a procedural flowchart of a service valuation module for the valuation of services in the system of FIG. 1 for the valuation of services; and

FIG. 4 shows a procedural flowchart of a market facilitation module 34 for the facilitation of a sales session in the system of FIG. 1 for the valuation of services.

### DETAILED DESCRIPTION

A system for the valuation of services within a market to promote the clearing of service capacity to consumers is described hereinafter for addressing the foregoing problems. In embodiments of the invention, a method and a system for the valuation of services are implemented in tandem with a system for market facilitation to achieve this.

A service is offered with at least one service profile. The service profile defines a combination of any profile attributes. Each profile attribute describes a particular characteristic associated with the service. Therefore, the service profile presents a set of characteristics for the service. The system for the valuation of services allows a variation of service profiles to be designed by the administrator, each having a respective price. The buyer selects at least one service profile and is required to rank the profiles according to preference if more than one service profile is selected. The buyer is also presented with information on the number of residual services, and the number of selections for a service profile.

The market facilitation system provides a framework for a sales session in which sellers sell to at least one buyer. Within this framework, buyers can view a seller's offer price for a service during an offer period that has been pre-defined by an administrator and make offers to buy the service. At the end of the offer period, the market facilitation system proceeds, instantaneously or after an elapsed time, to choose the number of buyers to receive the service for the price based on the respective service profile chosen. The buyers are selected based on a set of criterions pre-defined by the administrator.

For illustrative purposes, the systems are applied in, for example, the airline industry. In the example, hereinafter described as the airline example, airline tickets of limited supply are being offered for sale. Initially, an administrator determines in a airline market facilitation system the duration of an offer period for a service, the service being the offering of a set of airline tickets for sale. Each ticket is offered with a service profile. Each service profile contains a combination of any profile attributes such as class of air travel, complementary services, return duration, number of transit stops, number of allowable baggage and the like attributes. A potential buyer uses the Internet or any other communication system to log onto the market facilitation system. The potential buyer is shown all the service profiles for the service, the corresponding offer price for each service profile, the number of tickets remaining, and the number of selections by other buyers for each service profile. The buyer proceeds to select one or more service profiles. The buyer is required to rank the service profiles based on preference if more than one service profile is selected. The buyer can only accept an offer within the offer period.

At the end of each offer period, information containing the buyers' service profile selections, preference ranking, corresponding offer price and the conditions under which the selections are made, i.e. number of tickets remaining and number of selections by other buyers, are consolidated and provided to the system for the valuation of services.

The system for the valuation of services then proceeds to re-design the existing service profiles and re-price the service profiles to be used in the next offer period for a new service. The new service offers for sale a new supply of airline tickets. Using the airline example, the service profile of the airline ticket may be redesigned in an airline related system for the valuation of services to include either a longer return duration but with an increased number of transit stops for one service profile, or an increased number of allowable baggage with a reduced return duration for another service profile.

The re-priced service profiles reflect the value that the majority of buyers place on a service, given the number of residual services, and the number of selections for a service profile at a particular time prior to the commencement of the service. This in turn facilitates the clearing of residual service capacity at any instance; with the services priced for maximum profit at a level that a majority of buyers are still willing to pay.

As in the case of an airline ticket, the service perishes upon the commencement of the service (i.e. the seat within a flight will be left empty). Therefore, by studying the factors influencing a buyer's service profile preference, and the influence of a buyer's knowledge of both the number of tickets remaining and the number of selections by other buyers for each service profile at a particular time, the airline is able to desirably price the airline ticket to effect the faster clearing of available airline tickets.

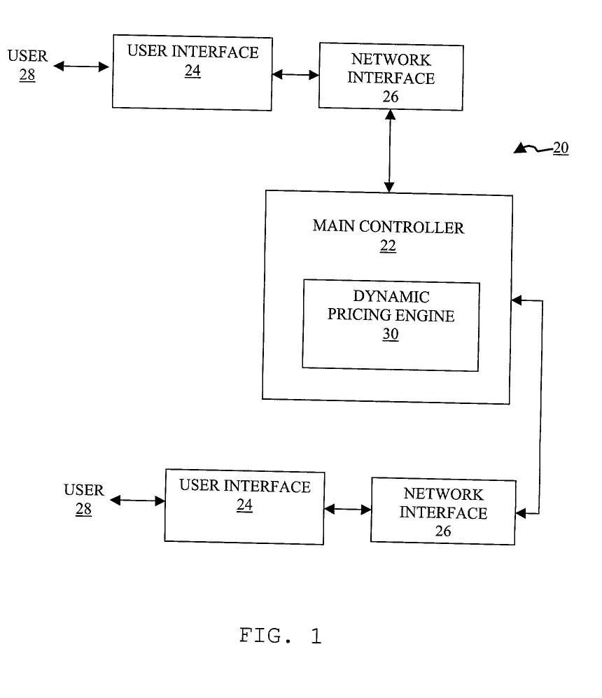

FIG. 1 shows a block diagram representing a system for the valuation of services 20, implemented over a communication network. A main controller 22 within the system for the valuation of services 20 is accessed using a user interface 24. The user interface 24 is interfaced to the main controller 22 by the use of a network interface 26. A user 28 accesses the system for the valuation of services 20 by the use of the user interface 24. A dynamic pricing engine 30 resides within the main controller 22.

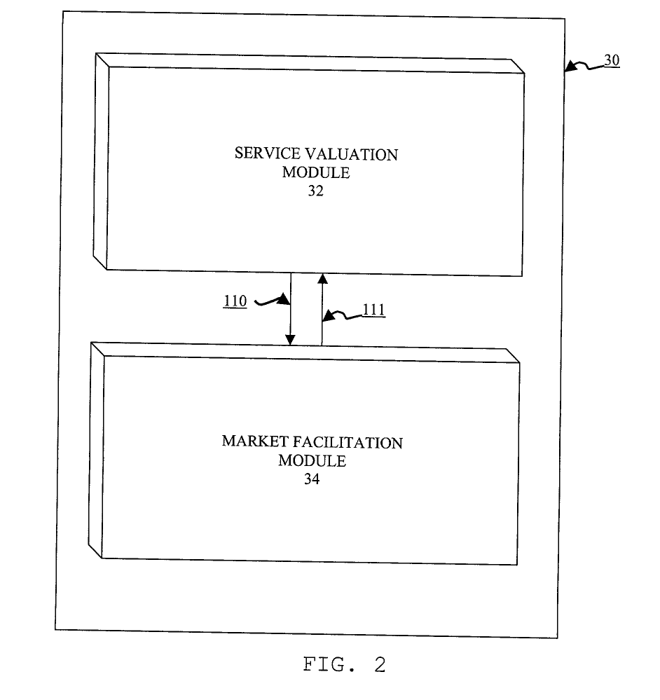

FIG. 2 shows a block diagram representing the dynamic pricing engine 30. The dynamic pricing engine 30 contains a service valuation module 32 and a market facilitation module 34 which are interconnected for the conveyance of information or data therebetween.

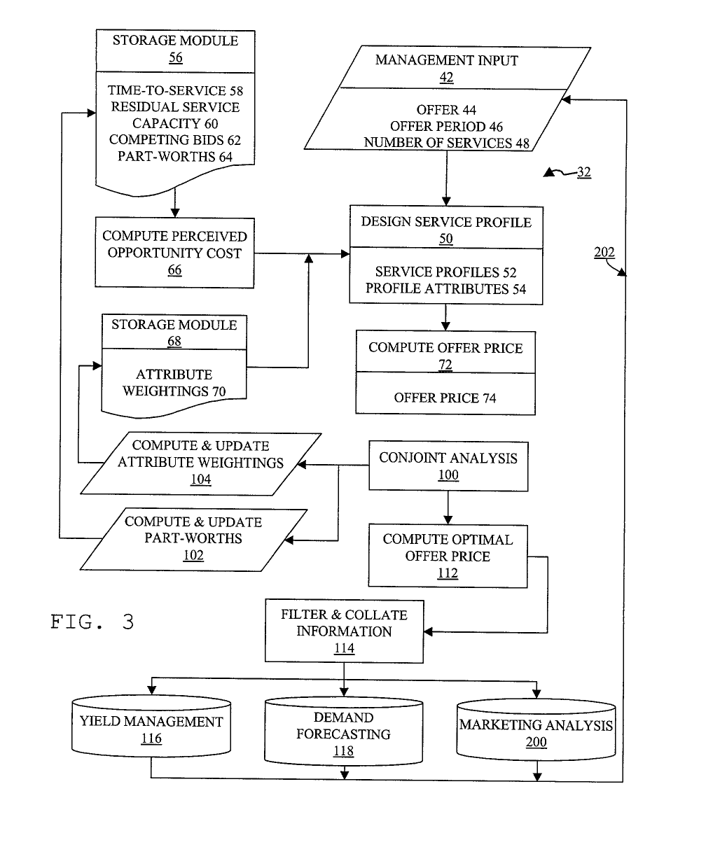

FIG. 3 shows a procedural flowchart of the service valuation module 32 for the valuation of services. An administrator initiates the system for the valuation of services 20 by providing management input 42 for an offer 44 to the service valuation module 32. The management input 42 includes the duration of an offer period 46 for the offer 44, and the number of services 48 to be offered during the offer period 46.

A first storage module 56 contains a time-to-service indication 58, a residual service capacity quantification 60, a competing bids quantification 62, and their respective part-worth 64. Each of the time-to-service indication 58, the residual service quantification 60, the competing bids quantification 62, and each profile attribute 54 has a part-worth 64 indicating their respective worth. The time-to-service indication 58 indicates the time remaining before the commencement of a service offered 44. The time-to-service indication 58, the residual service capacity quantification 60, and the competing bids quantification 62 are constantly updated by the first storage module 56. The respective part-worth 64 of the time-to-service indication 58, the residual service capacity quantification 60, and the competing bids quantification 62 are initially provided to the first storage module 56 by the administrator. A perceived opportunity cost 66 is then generated based on the residual service quantification 60, and the competing quantification bids 62 in relation to a particular time-to-service 58, and their respective part-worth 64.

Using the information derived from the management input 42, the administrator proceeds to design 50 at least one service profile 52 for a service; each service profile 52 defining a combination of any profile attributes 54. The administrator provides a second storage module 68 with an initial list of respective attribute weightings 70 for the profile attributes 54. An attribute weighting 70 indicates the level of importance of a profile attribute 54.

Based on the attribute weightings 70 of the combination of profile attributes defined by each service profile 52, and the perceived opportunity cost 66, the offer price 74 for each service profile 52 is computed 72. With reference to FIG. 2, the offer price 74, the time-to-service indication 56, the residual service capacity quantification 60 and the competing bids quantification 62 from the service valuation module 32, are then provided 110 to the market facilitation module 34.

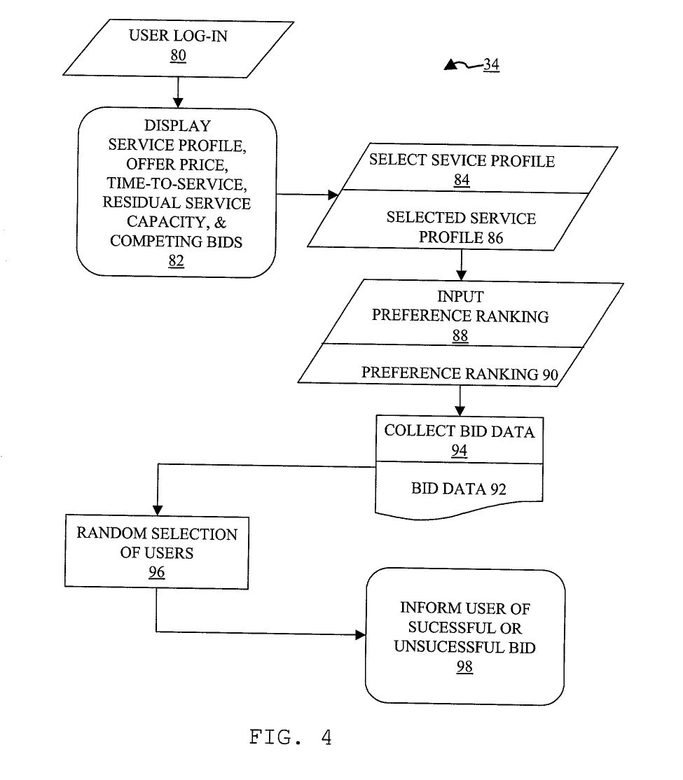

FIG. 4 shows a procedural flowchart of the market facilitation module 34 for the facilitation of a sales session. Initially, a user log-in module 80 allows a user 28 to access the system for the valuation of services 20. During the offer period 46 for the offer 44, information on the service profiles 52, the respective offer price generated 74, the time-to-service 58, the residual service capacity 60 and the number of competing bids 62 are obtained from the service valuation module 32 and displayed 82 to the user 28. The user 28 proceeds to select 84 at least one service profile 52 to produce a list of selected service profiles 86. If a user 28 selects more than one service profile 86, the user 28 proceeds to assign 88 a preference rank 90 to each of the service profile 88 selected. Bid data 92 for each selected service profile 88 is then collected 94. The bid data 92 contains the identity of the user 28, the user's 28 selected service profile 88, the respective preference rank 90, the residual service capacity 60, and the number of competing bids 62 at a particular time-to-service 58.

At the end of the offer period 46, the administrator selects 96 the users 28 to make the offer 44 for the allocated services 52, using information of the user's selected service profile 86 and the respective preference rank 90. The number of users 28 selected should not exceed the number of services 48. The selection 96 of the users 28 is performed either instantaneously at the end of the offer period 46 or after an elapsed time. The selected and unselected users are then informed about the success of their bid 98 by the market facilitation system 34. Means for informing the user 28 about the success of their bid 98 are for example, the Internet, the e-mail, electronic messaging systems and the like communication systems.

With reference to FIG. 2 and FIG. 3, the bid data 92 containing the identity of the user 28, the user's 28 selected service profile 88, the respective preference rank 90, the residual service capacity 60, and the number of competing bids 62 at a particular time-to-service 58 are then provided 111 to the service valuation module 32. A conjoint analysis 100 is performed within the service valuation module 32 on the bid data 92 collected from within the market facilitation module 34. The conjoint analysis 100, computes a new part-worth 102 for the time-to-service indication 58, the residual service capacity quantification 60, the competing bids quantification 62, and each profile attribute 54 and updates 102 the part-worths 64 in the first storage module 56. The conjoint analysis 100 also computes the new attribute weightings 104 and updates 104 the attribute weightings 70 in the second storage module 68.

The perceived opportunity cost is computed 66 using the updated 102 part-worths 64. Following this, the offer price 74 of each service profile 52 for the next offer 44 is computed, and the procedural flow of both the service valuation module 32 and the market facilitation module 34 is reiterated. Facilitated by both the flow 110 of updated service profiles 52 and their respective offer price 74 from the service valuation module to the market facilitation module, and the flow 111 of the new bid data from the market facilitation module to the service valuation module, the optimal offer price 112 of each service profile 52 is computed after a number of iterations.

Information from the bid data 92, the conjoint analysis 100, and the optimal offer price 112 is further filtered and collated 114, for the purposes of yield management 116, demand forecasting 118, and marketing analysis 200. Results and information derived from yield management 116, demand forecasting 118, and the marketing analysis 200 are fed back in a feed-back loop 202 so as to facilitate, aid or influence management input 42 to be provided to the system for the valuation of service 10 by the administrator.

In the foregoing manner, a dynamic pricing engine for use in the valuation of services is described according to an embodiment of the invention for addressing the foregoing disadvantages of traditional pricing models. Although only one embodiment of the invention is disclosed, it will be apparent to one skilled in the art in view of this disclosure that numerous changes and/or modification can be made without departing from the scope and spirit of the invention.

1. A method for the valuation of services, the method comprising the steps of:
generating at least one service profile for a service, a service profile defining a combination of any of a plurality of profile attributes, wherein each profile attribute represents a particular characteristic of that the service profile can possess;
generating a price for each service profile;
providing to a user, for each service profile, a residual services quantification, the residual services indicating the number of remaining services, a competing bids quantification, the competing bids quantifying the cumulative number of selections for each service profile by previous users, and a time-to-service indication, the time-to-service indicating the time remaining prior to the commencement of a service;
selecting one or more service profiles by the user;
creating a selected profiles list, the selected profiles list containing the service profiles selected by the user; and
updating the price for each service profile.

2. The method as claimed in claim 1, further comprising the step of accepting from the user a preference rank for each of the service profile in the selected profiles list.

3. The method as claimed in claim 2, further comprising the step of accepting a plurality of part-worths from an administrator, the part-worth indicating the worth of either the residual service quantification, competing bids quantification, the time-to-service indication, or a profile attribute, and the part-worth being pre-specified by the administrator;

4. The method as claimed in claim 3, further comprising the step of assigning an attribute weighting to each profile attribute by the administrator, the attribute weighting indicating the level of influence of the profile attribute over a user.

5. The method as claimed in claim 4, wherein the price of the service profile is generated based on the respective attribute weighting of the combination of profile attributes defining the service profile.

6. The method as claimed in claim 5, further comprising the step of constantly updating the residual services quantification, the competing bids quantification, and the time-to-service indication.

7. The method as claimed in claim 6, further comprising the step of:
registering the residual services quantification, the competing bids quantification, and the time-to-service indication for the service profile corresponding to the time the service profile is selected by the user.

8. The method as claimed in claim 7, further comprising the step of:
generating a perceived opportunity cost for a service profile, the perceived opportunity cost being dependant on the registered residual services quantification, competing bids quantification, time-to-service indication, and the respective part-worth.

9. The method as claimed in claim 8, further comprising the step of:
performing a conjoint analysis on the service profiles contained in the selected profiles list, the respective preference rank, and the corresponding residual services quantification, competing bids quantification, and time-to-service indication.

10. The method as claimed in claim 9, further comprising the steps of:
computing and updating the attribute weighting of each profile attribute based on the conjoint analysis; and
computing and updating, based on the conjoint analysis, the respective part-worth of the residual service capacity quantification, the competing bids quantification, the time-to-service indication, and each profile attribute.

11. The method as claimed in claim 10, wherein the price of the service profile is updated based on both the perceived opportunity cost and the respective attribute weighting of the combination of profile attributes defining the service profile.

12. The method as claimed in claim 11, further comprising the step of:
redesigning for the service, a new service profile to define a new combination of any of the plurality of profile attributes, the new combination of profile attributes being based on the attribute weighting of each profile attribute derived from the conjoint analysis, and being redesigned by the administrator.

13. The method as claimed in claims 12, further comprising the step of:
generating a new price for the new service profile, the new price being based on the perceived opportunity cost and the attribute weighting of each of the new combination profile attributes defining the new service profile.

14. The method as claimed in claim 13, wherein the selected service profiles and their respective preference ranking are accepted from the user within a predetermined duration.

15. A system for the valuation of services, the system comprising the means for:
generating at least one service profile for a service, a service profile defining a combination of any of a plurality of profile attributes, wherein each profile attribute represents a characteristic of the service profile;
generating a price for each service profile;
providing to a user, for each service profile, a residual services quantification, the residual services indicating the number of remaining services, a competing bids quantification, the competing bids quantifying the cumulative number of selections for each service profile by previous users, and a time-to-service indication, the time-to-service indicating the time remaining prior to the commencement of a service;
selecting one or more service profiles by the user;
creating a selected profiles list, the selected profiles list containing the service profiles selected by the user; and
updating the price for each service profile.

16. The system as claimed in claim 15, further comprising the means for accepting from the user a preference rank for each of the service profile in the selected profiles list.

17. The system as claimed in claim 16, further comprising the means for accepting a plurality of part-worths from an administrator, the part-worth indicating the worth of either the residual service quantification, competing bids quantification, the time-to-service indication, or a profile attribute, and the part-worth being pre-specified by the administrator;

18. The system as claimed in claim 17, further comprising the means for assigning an attribute weighting to each profile attribute by the administrator, the attribute weighting indicating the level of influence of the profile attribute over a user.

19. The system as claimed in claim 18, wherein the price of the service profile is generated based on the respective attribute weighting of the combination of profile attributes defining the service profile.

20. The system as claimed in claim 19, further comprising the means for constantly updating the residual services quantification, the competing bids quantification, and the time-to-service indication.

21. The system as claimed in claim 20, further comprising the means for:
registering the residual services quantification, the competing bids quantification, and the time-to-service indication for the service profile corresponding to the time the service profile is selected by the user.

22. The system as claimed in claim 21, further comprising the means for:
generating a perceived opportunity cost for a service profile, the perceived opportunity cost being dependant on the registered residual services quantification, competing bids quantification, time-to-service indication, and the respective part-worth.

23. The system as claimed in claim 22, further comprising the means for:
performing a conjoint analysis on the service profiles contained in the selected profiles list, the respective preference rank, and the corresponding residual services quantification, competing bids quantification, and time-to-service indication.

24. The system as claimed in claim 23, further comprising the means for:
computing and updating the attribute weighting of each profile attribute based on the conjoint analysis; and
computing and updating, based on the conjoint analysis, the respective part-worth of the residual service capacity quantification, the competing bids quantification, the time-to-service indication, and each profile attribute.

25. The system as claimed in claim 24, wherein the price of the service profile is updated based on both the perceived opportunity cost and the respective attribute weighting of the combination of profile attributes defining the service profile.

26. The system as claimed in claim 25, further comprising the means for:
redesigning for the service, a new service profile to define a new combination of any of the plurality of profile attributes, the new combination of profile attributes being based on the attribute weighting of each profile attribute derived from the conjoint analysis, and being redesigned by the administrator.

27. The system as claimed in claims 26, further comprising the means for:
generating a new price for the new service profile, the new price being based on the perceived opportunity cost and the attribute weighting of each of the new combination profile attributes defining the new service profile.

28. The system as claimed in claim 27, wherein the selected service profiles and their respective preference ranking are accepted from the user within a predetermined duration.
